(19) United States
(12) Patent Application Publication
(10) Pub. No.: US 2009/0034156 A1
(43) Pub. Date: Feb. 5, 2009

(54) COMPOSITE SHEET

(76) Inventor: TAKUYA YAMAMOTO, Ageo City (JP)

Correspondence Address: ROBERTS & ROBERTS, LLP;ATTORNEYS AT LAW, P.O. BOX 484, PRINCETON, NJ, 08542-0484, US

(21) Appl. No.: 11/830,244

(22) Filed: Jul. 30, 2007

(51) Int. Cl. H01G 4/06; H01B 3/00

(52) U.S. Cl. 361/311; 174/137 R

(57) ABSTRACT

Composite materials for the formation of printed circuit boards and electronic devices. A composite structure of the invention includes an electrically conductive layer and a dielectric layer. The dielectric layer includes a plurality of adjacent dielectric material patches arranged in a patchwork configuration, which patches are made up of different dielectric materials to thereby result in areas of differential capacitance.

### BACKGROUND OF THE INVENTION

1. Field of the Invention

The present invention relates to the formation of electronic devices. More particularly, the invention relates to dielectric material layers and composite materials used in the formation of printed circuit boards and electronic devices.

2. Description of the Related Art

As feature sizes in printed circuit boards are reduced, problems relating to power distribution, generated impedances, and electromagnetic emissions (EMI) have become increasingly difficult to resolve.

A common element on a printed circuit board or other microelectronic device is a capacitor. Capacitors are used to introduce capacitance into a circuit, and to steady the operational power supply of such devices. They function primarily to store electrical energy, block the flow of direct current, or permit the flow of alternating current. A typical capacitor include a dielectric material sandwiched between two electrically conductive metal layers, such as copper foils.

Various types of dielectric materials are known in the art. For example, the dielectric material may be a gas, such as air, a vacuum, a liquid, a solid or a combination thereof. Each material has its own particular properties. In forming capacitors for use in printed circuit boards, a dielectric material such as a glass reinforced polymer matrix has been used. However, the performance of capacitors of this type have not been optimal. U.S. Pat. Nos. 5,155,655 and 5,161,086 describe a method for forming a capacitor wherein a single sheet of a dielectric material is laminated between two conductive foils. While there have been previous efforts to apply low dielectric constant materials to integrated circuits and the like, there remains a longstanding need in the art for further improvements relating to problems with power distribution, generated impedances, and electromagnetic emissions.

Accordingly, it has now been found that these problems can be mitigated by forming a dielectric layer having areas of differential capacitance as a component of a printed circuit board or the like. The invention includes a dielectric layer having a plurality of adjacent patches arranged in a patchwork configuration, wherein the patches are made up of different materials. When such a dielectric layer is positioned between two conductive layers, a capacitor results which has areas of differential capacitance.

The dielectric layers and composite structures of the invention serve to improve power distribution and reduce electromagnetic imission (EMI) in printed circuit boards and the like.

### SUMMARY OF THE INVENTION

The invention provides a dielectric layer suitable for use as a part of a electronic device, which dielectric layer comprises a plurality of adjacent patches arranged in a patchwork configuration, wherein one or more patches comprise a first dielectric material, and one or more other patches comprise a different dielectric material.

The invention also provides a composite structure suitable for use as a substrate for an electronic device, which structure comprises:

a) an electrically conductive layer; and

b) a dielectric layer on the electrically conductive layer, which dielectric layer comprises a plurality of adjacent patches arranged in a patchwork configuration, wherein one or more patches comprise a first dielectric material, and one or more other patches comprise a different dielectric material.

The invention further provides a method for forming a composite structure suitable for use as a substrate for an electronic device, which method comprises the steps of:

a) providing an electrically conductive layer;

b) forming a dielectric layer on the electrically conductive layer, which dielectric layer comprises a plurality of adjacent patches arranged in a patchwork configuration, wherein one or more patches comprise a first dielectric material, and one or more other patches comprise a different dielectric material.

### BRIEF DESCRIPTION OF THE DRAWINGS

FIG. 1 shows a schematic representation view of a cross section of one embodiment of a composite structure according to the invention showing a patchwork dielectric layer on an electrically conductive layer.

FIG. 2 shows a schematic representation view of a cross section of another embodiment of a composite structure according to the invention showing an additional electrically conductive layer on the structure of FIG. 1.

FIG. 3 shows a schematic representation view of a cross section of another embodiment of a composite structure according to the invention showing a polymeric layer between the patchwork dielectric layer and the electrically conductive layer of FIG. 1.

FIG. 4 shows a schematic representation view of a cross section of another embodiment of a composite structure according to the invention showing a polymeric layer on top of the patchwork dielectric layer of FIG. 1.

FIG. 5 shows a schematic representation view of a cross section of another embodiment of a composite structure according to the invention showing an additional patchwork dielectric layer on the structure of FIG. 4.

FIG. 6 shows a schematic representation view of a cross section of another embodiment of a composite structure according to the invention showing an additional electrically conductive layer on the structure of FIG. 5.

### DETAILED DESCRIPTION OF THE PREFERRED EMBODIMENT

The invention relates to the formation of dielectric layers and composite structures suitable for use as parts or components of electronic devices and the like. The invention also relates to a method for forming a composite structure suitable for use as a substrate for an electronic device.

A dielectric layer is formed according to the present invention. This dielectric layer comprises a plurality of adjacent patches of dielectric material which are arranged in a patchwork configuration. Some of the patches comprise a first dielectric material, and other patches comprise a different dielectric material. For purposes of this invention, the first dielectric material and the different dielectric material should not be identical. For example, they may have a different chemical composition, or they may have additional components such as fillers, or they may be of a different thickness.

The patchwork dielectric layer may be formed on a suitable substrate, such as an electrically conductive layer as described below, by one or more of several different application or deposition methods. For purposes of this invention unless otherwise specified, applying, attaching, placing, depositing, or forming can mean any well known method of appending one layer to the next layer, non-exclusively including coating, dipping, spraying, sputtering, laminating, vapor depositing, electrodeposition, plating, printing, evaporating, and combinations thereof, either simultaneously or sequentially.

In one embodiment, the dielectric layer comprises a sheet comprising the first dielectric material and having a plurality of perforations therethrough, and wherein at least some of the perforations contain patches of the different dielectric material positioned within the perforations. A dielectric layer according to this embodiment may be formed on a substrate by depositing one or more dielectric material patches on the substrate, preferably directly onto a surface of the substrate, and then placing a dielectric sheet having perforations onto the substrate, preferably directly onto a surface of the substrate, such that the one or more dielectric material patches are positioned through the perforations. In another embodiment, such a dielectric layer may be formed on a substrate by placing a dielectric sheet comprising the first dielectric material, and having a plurality of perforations therethrough, on to a substrate, preferably directly onto a surface of the substrate. One or more patches of the different dielectric material are then deposited on the electrically conductive layer through the perforations, preferably directly on a surface of the substrate, such that they are positioned within the perforations. In a preferred embodiment, the substrate comprises an electrically conductive layer as described below.

According to the invention, the first dielectric material and the different dielectric material each independently comprise a suitable electrically insulating material known in the art. Preferred materials nonexclusively include polymer materials such as epoxies, modified epoxies, melamines, unsaturated polyesters, urethanes, alkyds, bis-maleimide triazines, polyimides, esters, allylated polyphenylene ethers, polyamide, polytetrafluoroethylene, fiberglass, filled mesh, aramid paper, and combinations thereof. Preferred examples of modified epoxies includes doped epoxies, such as a barium titanate doped epoxy.

In one embodiment of the invention, at least one of the first dielectric material and the different dielectric material independently comprises a polymer material as above, incorporated with particles having a dielectric constant higher than that of the polymer material. Suitable particles of higher dielectric constant material nonexclusively include one or more filler materials. Preferred fillers non-exclusively include powdered ferroelectric materials, barium titanate (BaTiO₃), boron nitride, aluminum oxide, strontium titanate, barium strontium titanate, and other ceramic fillers and combinations thereof. If incorporated, a filler is preferably present in the dielectric layer in an amount of from about 5% to about 80% by volume of the layer, more preferably from about 10% to about 50% by volume of the layer. Preferably the dielectric layer comprises such a powdered filler having a dielectric constant of about 10 or higher. In addition, the polymeric layer may contain dyes or pigments to impart color, alter dielectric opacity, or affect contrast.

In another embodiment of the invention, these particles may be conductive particles. Suitable conductive particles nonexclusively include carbon black, carbon nanotubes, metal powders, metal oxide powders, and combinations thereof. The particles preferably range in size from about 10 nm to about 2 μm, preferably from about 100 nm to about 1 μm and more preferably from about 200 nm to about 500 nm.

The patches of the dielectric layer are arranged in a patchwork configuration wherein the patches independently comprise materials having properties which differ from adjacent patches. Preferably, the patchwork configuration serves to create zones of varying capacitance. The patches which comprise the first dielectric material and the patches which comprise the different dielectric material independently comprise materials which, when positioned between opposing conductive layers, form capacitive zones having different capacitances. In another embodiment, adjacent patches may comprise the same composition which have different thicknesses. In another embodiment, the patches which comprise the first dielectric material and the patches which comprise the different dielectric material have different chemical compositions. In another embodiment, the patches which comprise the first dielectric material and the patches which comprise the different dielectric material have different dielectric constants.

The patchwork configuration may be present in several different formations. The patches may be in a staggered formation, checkerboard formation, alternating formation, or the like. In one embodiment of the invention, the dielectric layer may be formed from a dielectric sheet having a plurality of perforations therethrough, which dielectric sheet comprises a first dielectric material, wherein patches or areas of a different dielectric material are positioned within the perforations.

The dielectric layer is preferably substantially planar, and has an overall thickness ranging from about 1 μm to about 200 μm, more preferably from about 3 μm to about 75 μm, and most preferably from about 5 μm to about 25 μm.

The dielectric layers formed according to the invention may be used for a variety of purposes such as in the formation of composite structures for electronic devices, microelectronic devices, electronic filtering devices, high or low bandpass filters, circuit boards, chip packages, and the like.

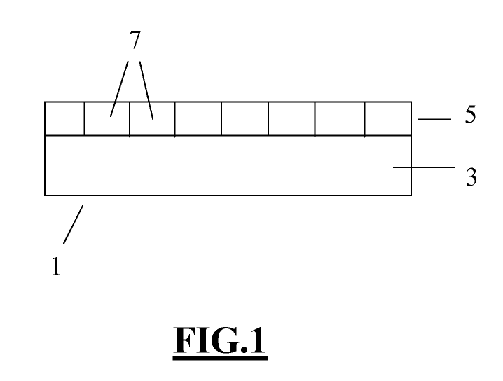

One particular embodiment of the invention includes a composite structure suitable for use as a substrate for an electronic device or the like. As shown in FIG. 1, a composite structure 1 preferably comprises an electrically conductive layer 3, and a dielectric layer 5 on the electrically conductive layer 3, which dielectric layer 5 comprises a plurality of dielectric patches 7. In one embodiment, the dielectric layer 5 is present directly on a surface of the electrically conductive layer 3.

The electrically conductive layer may comprise any suitable metal which is known in the art for use as a conductive metal layer for capacitors, printed wiring boards, and the like. The electrically conductive layer preferably comprises a material selected from the group consisting of copper, zinc, brass, chrome, nickel, aluminum, stainless steel, iron, gold, silver, titanium and combinations and alloys thereof. Most preferably, the electrically conductive layer comprises copper. The electrically conductive layer preferably has a thickness of from about 1 μm to about 400 μm, more preferably ranging from about 5 μm to about 105 μm, and most preferably ranging from about 9 μm to about 70 μm. The electrically conductive layers used according to this invention may be manufactured with a shiny side surface and a matte surface. Examples of such conductive materials are disclosed in U.S. Pat. No. 5,679,230, which is incorporated herein by reference.

The electrically conductive layer may be formed by any suitable means known in the art. Copper foils are known to be produced by electrodepositing copper from solution onto a rotating metal drum. The side of the foil next to the drum is typically the smooth or shiny side, while the other side has a relatively rough surface, also known as the matte side. This drum is usually made of stainless steel or titanium which acts as a cathode and receives the copper as it is deposited from solution. An anode is generally constructed from a lead alloy. A cell voltage of about 5 to 10 volts is applied between the anode and the cathode to cause the copper to be deposited, while oxygen is evolved at the anode. This copper foil is then removed from the drum and cut to the required size.

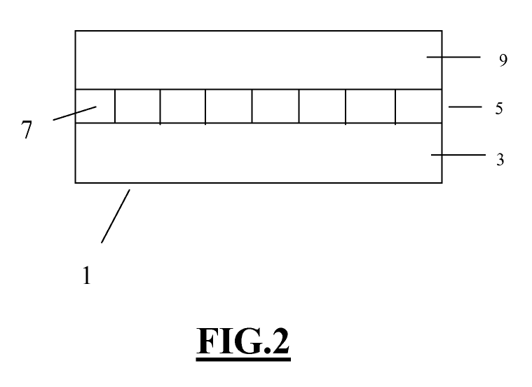

In one embodiment, shown in FIG. 2, the composite structure 1 comprises an additional electrically conductive layer 9 on the dielectric layer 5, preferably on a surface of the dielectric layer 5 which is opposite the electrically conductive layer 3 thereon. The additional electrically conductive layer 9 comprises a material which is independently selected from the materials described above for the electrically conductive layer 3, and may or may not comprise the same material and/or other properties, such as thickness and the like, as the electrically conductive layer 3. For purposes of this invention, the materials and properties suitable for the electrically conductive layer 3 and the additional electrically conductive layer 9 may vary depending on the desired application. In a preferred step of the invention, an electrically conductive layer is laminated to the dielectric layer. In another preferred step, an additional electrically conductive layer is laminated onto the dielectric layer. Suitable lamination procedures are described below.

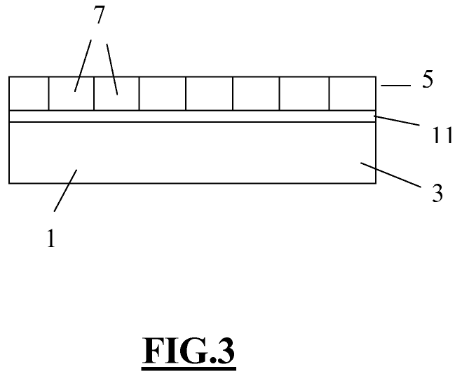

In another embodiment of the invention, shown in FIG. 3, the composite structure 1 comprises a polymeric layer 11 positioned between the electrically conductive layer 3 and the dielectric layer 5. The polymeric layer 11 serves to deter the formation of electrical shorts in the structure. Suitable materials for the polymeric layer 11 nonexclusively include an epoxy, a combination of epoxy and a material which polymerizes with an epoxy, a melamine, an unsaturated polyester, a urethane, alkyd, a bis-maleimide triazine, a polyimide, an ester, an allylated polyphenylene ether (or allyl-polyphenylene ether) or combinations thereof.

The polymeric layer may also optionally comprise one or more filler materials. Preferred fillers non-exclusively include powdered ferroelectric materials, barium titanate (BaTiO₃), boron nitride, aluminum oxide, strontium titanate, barium strontium titanate, and other ceramic fillers and combinations thereof. If incorporated, a filler is preferably present in the polymeric layer in an amount of from about 5% to about 80% by volume of the layer, more preferably from about 10% to about 50% by volume of the layer. Preferably the polymeric layer comprises such a powdered filler having a dielectric constant of about 10 or higher. In addition, the polymeric layer may contain dyes or pigments to impart color, alter dielectric opacity, or affect contrast.

The polymeric layer may be applied using any suitable application methods known in the art or as described above. The polymeric layer is preferably applied in the form of a liquid polymer solution to allow for control and uniformity of the polymer thickness. The liquid polymer solution will typically have a viscosity ranging from about 50 to about 35,000 centipoise with a preferred viscosity in the range of 100 to 27,000 centipoise. The liquid polymer solution typically will include from about 10 to about 80% and preferably from about 15 to about 60 wt % polymer with the remaining portion of the solution comprising one or more solvents. Useful solvents include acetone, methyl-ethyl ketone, N-methyl pyrrolidone, N, N dimethylformamide, N, N dimethylacetamide and mixtures thereof. A preferred single solvent is methyl-ethyl ketone.

Preferably, the polymeric layer has a thickness of from about 2 to about 200 microns, more preferably from about 2 to about 100 microns. The polymer layer also preferably has a dielectric strength of at least about 19,685 volts/mm (500 volts/mil) thickness.

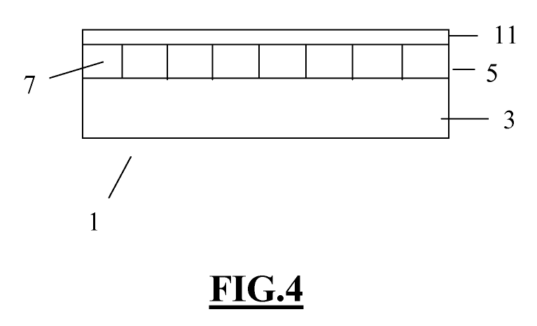

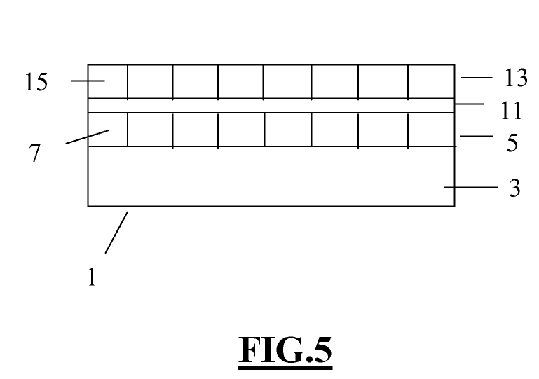

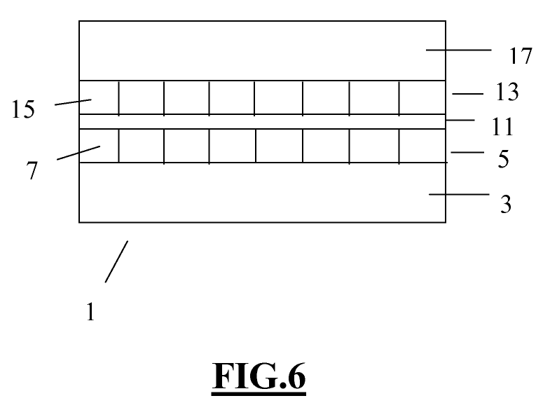

Several other embodiments of the invention include such a polymeric layer. One such embodiment, shown in FIG. 4, includes a composite structure 1 as described above, which comprises an electrically conductive layer 3 and a dielectric layer 5 thereon, further comprises a polymeric layer 11 present on the dielectric layer 5, preferably on a surface opposite the electrically conductive layer 3. In a further embodiment, shown in FIG. 5, an additional dielectric layer 13 is present on the polymer layer 11, preferably on a surface opposite the first dielectric layer 5. In a further embodiment, shown in FIG. 6, an additional electrically conductive layer 17 is present on the additional dielectric layer 13, preferably on a surface opposite the polymeric layer 11 thereon. It should be noted that the additional dielectric layer 13 comprises dielectric material patches 15 which are independently selected from the materials described above for the dielectric layer 5, and may or may not comprise the same material and/or other properties, such as thickness and the like, as the dielectric layer 5. For purposes of this invention, the materials and properties suitable for the dielectric layer 5 and the additional dielectric layer 13 may vary depending on the desired application.

In one embodiment of the invention, a polymeric layer is positioned between the electrically conductive layer and the dielectric layer. In a further embodiment, an additional polymeric layer is positioned on the dielectric layer which is opposite the polymeric layer thereon, and an additional electrically conductive layer is positioned on the additional polymeric layer which is opposite the dielectric layer. In such an embodiment, it is preferred to further comprise the step of laminating the entire structure such that the polymeric layer and/or the additional polymeric layer surround the patches of the dielectric layer. Furthermore, the dielectric layer may comprise a sheet comprising the first dielectric material having a plurality of perforations therethrough, and wherein at least some of the perforations contain patches of the different dielectric material positioned within the perforations. Thus, it may be preferred for the polymeric layer and/or the additional polymeric layer fill at least some of the perforations through the sheet of first dielectric material. In such an embodiment, the entire composite structure may be laminated such that the polymeric layer and/or the additional polymeric layer fill at least some of the perforations through the sheet of first dielectric material.

Lamination may be conducted in a press at a temperature of from about 150° C. to about 310° C., more preferably from about 160° C. to about 200° C. Lamination may be conducted for from about 30 minute to about 120 minutes, preferably from about 40 minutes to about 80 minutes. Preferably, the press is under a vacuum of at least 70 cm (28 inches) of mercury, and maintained at a pressure of about from about 3.5 kgf/cm² (50 psi) to about 28 kgf/cm² (400 psi), preferably from about 4.9 kgf/cm² (70 psi) to about 14 kgf/cm² (200 psi).

The following non-limiting examples serve to illustrate the invention. It will be appreciated that variations in proportions and alternatives in elements of the components of the invention will be apparent to those skilled in the art and are within the scope of the present invention.

### EXAMPLE 1

A sheet of fiberglass cloth that is impregnated with epoxy resin (resulting in a thickness of 50 micrometers) that is partially cured (“B” Staged) is mechanically punched with a pattern that creates holes in the material. A sheet of copper foil that is 35 microns thick is placed on a rigid stainless steel plate with the bond enhancing treatment facing up. The patterned fiberglass cloth is placed on the copper foil. The fiberglass is temporarily taped to the copper to prevent moment. An epoxy resin system containing barium titanate at the level of 50% by weight is forced into the holes of the fiberglass using a squeegee being careful to remove any excess on the fiberglass surface. A top sheet of copper is placed onto the fiberglass with the bonding side down against the fiberglass. A stainless steel plate is then placed on the top copper. The process is repeated until the desired number of sheets was obtained (as an example, 10 sheets). This stack of stainless steel plates, with the substrates in between, is placed on top of a steel carrier plate that has a press pad (to evenly distribute heat and pressure) on it. A top press pad is placed on the stack. The product is transported into an hydraulic laminating press. The press doors are closed and a vacuum of less than 20 inches Hg is obtained. The substrates are pressed at 300 psi and 395 degrees F. for a total of 60 minutes at temperature. The stack is transferred to a cooling press to bring it down to room temperature. The individual substrates are removed from the steel plates and electrically tested using a high potential test (voltage increased from 0 to 500 volts with a ramp rate of 25 volts/second). If no shorts are detected the substrate is trimmed to size. The trimmed substrates are processed in a traditional printed circuit board process to etch the patterns into the copper. The etched substrates receive a bond enhancing treatment to the copper (usually a form of copper oxide) and are laminated into a multilayer circuit board with other circuit pattern layers utilizing more sheets of the impregnated fiberglass. The printed circuit board is finished by drilling holes to connect the layers, plating the holes and external copper traces and performing electrical testing for shorts and opens. The printed circuit board is then assembled using various active and passive components.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A dielectric layer suitable for use as a part of a electronic device, which dielectric layer comprises a plurality of adjacent patches arranged in a patchwork configuration, wherein one or more patches comprise a first dielectric material, and one or more other patches comprise a different dielectric material.

2. The dielectric layer of claim 1 which layer is substantially planar.

3. The dielectric layer of claim 1 wherein the patches which comprise the first dielectric material and the patches which comprise the different dielectric material form capacitors having different capacitances when the patches are positioned between two conductive layers.

4. The dielectric layer of claim 1 wherein the patches which comprise the first dielectric material have different thicknesses compared to the patches which comprise the different dielectric material.

5. The dielectric layer of claim 1 wherein the patches which comprise the first dielectric material and the patches which comprise the different dielectric material have different chemical compositions.

6. The dielectric layer of claim 1 wherein the patches which comprise the first dielectric material and the patches which comprise the different dielectric material have different dielectric constants.

7. The dielectric layer of claim 1 wherein the first dielectric material and the different dielectric material each independently comprise a material selected from the group consisting of epoxies, doped epoxies, melamines, unsaturated polyesters, urethanes, alkyds, bis-maleimide triazines, polyimides, esters, allylated polyphenylene ethers, polyamide, polytetrafluoroethylene, fiberglass, filled mesh, aramid paper, and combinations thereof.

8. The dielectric layer of claim 1 wherein at least one of the first dielectric material and the different dielectric material independently comprises a polymer material incorporated with particles of a material having a dielectric constant higher than that of the polymer material.

9. The dielectric layer of claim 1 wherein at least one of the first dielectric material and the different dielectric material independently comprises conductive particles.

10. The dielectric layer of claim 9 wherein the conductive particles comprise carbon black, carbon nanotubes, metal powders, metal oxide powders, and combinations thereof.

11. The dielectric layer of claim 1 wherein the dielectric layer has a thickness ranging from about 1 μm to about 200 μm.

12. The dielectric layer of claim 1 wherein the dielectric layer comprises a sheet comprising the first dielectric material and having a plurality of perforations therethrough, and wherein at least some of the perforations contain patches of the different dielectric material positioned within the perforations.

13. An electronic filtering device comprising the dielectric layer of claim 1.

14. A high or low bandpass filter comprising the dielectric layer of claim 1.

15. The dielectric layer of claim 1 which is present inside a circuit board or chip package.

16. A composite structure suitable for use as a substrate for an electronic device, which structure comprises:
a) an electrically conductive layer; and
b) a dielectric layer on the electrically conductive layer, which dielectric layer comprises a plurality of adjacent patches arranged in a patchwork configuration, wherein one or more patches comprise a first dielectric material, and one or more other patches comprise a different dielectric material.

17. The composite structure of claim 16 wherein the electrically conductive layer comprises a material selected from the group consisting of copper, zinc, brass, chrome, nickel, aluminum, stainless steel, iron, gold, silver, titanium and combinations and alloys thereof.

18. The composite structure of claim 16 wherein the electrically conductive layer comprises copper.

19. The composite structure of claim 16 wherein the dielectric layer is directly on a surface of the electrically conductive layer.

20. The composite structure of claim 16 wherein the electrically conductive layer has a thickness of from about 1 μm to about 400 μm.

21. The composite structure of claim 16 which further comprises an additional electrically conductive layer on the dielectric layer.

22. The composite structure of claim 16 which further comprises a polymeric layer present on the dielectric layer, opposite the electrically conductive layer.

23. The composite structure of claim 22 which further comprises an additional dielectric layer present on the polymeric layer, opposite the first dielectric layer.

24. The composite structure of claim 23 which further comprises an additional electrically conductive layer present on the additional dielectric layer which is opposite the polymeric layer thereon.

25. The composite structure of claim 16 which further comprises a polymeric layer positioned between the electrically conductive layer and the dielectric layer.

26. The composite structure of claim 25 which further comprises an additional polymeric layer on the dielectric layer which is opposite the polymeric layer thereon, and wherein an additional electrically conductive layer is present on the additional polymeric layer which is opposite the dielectric layer thereon.

27. The composite structure of claim 26 which has been laminated together such that the polymeric layer and the additional polymeric layer surround the patches of the dielectric layer.

28. The composite structure of claim 26 wherein the dielectric layer comprises a sheet comprising the first dielectric material and having a plurality of perforations therethrough, and wherein at least some of the perforations contain patches of the different dielectric material positioned within the perforations.

29. The composite structure of claim 28 wherein the polymeric layer and/or the additional polymeric layer fill at least some of the perforations through the sheet of first dielectric material.

30. A method for forming a composite structure suitable for use as a substrate for an electronic device, which method comprises the steps of:
a) providing an electrically conductive layer;
b) forming a dielectric layer on the electrically conductive layer, which dielectric layer comprises a plurality of adjacent patches arranged in a patchwork configuration, wherein one or more patches comprise a first dielectric material, and one or more other patches comprise a different dielectric material.

31. The method of claim 30 wherein the dielectric layer is formed on the electrically conductive layer by either of steps (i) or (ii):
(i) depositing one or more dielectric material patches onto a surface of the electrically conductive layer and then placing a dielectric sheet having perforations onto the surface of the electrically conductive layer such that the one or more dielectric material patches are positioned through the perforations; or
(ii) placing a dielectric sheet having perforations onto a surface of the electrically conductive layer and then depositing one or more dielectric material patches onto the surface of the electrically conductive layer through the perforations.

32. The method of claim 30 comprising laminating the electrically conductive layer to the dielectric layer.

33. The method of claim 30 further comprising the step of laminating an additional electrically conductive layer to the dielectric layer.

34. The method of claim 30 which further comprises positioning a polymeric layer between the electrically conductive layer and the dielectric layer.

35. The method of claim 34 which further comprises positioning an additional polymeric layer on the dielectric layer which is opposite the polymeric layer thereon, and positioning an additional electrically conductive layer on the additional polymeric layer which is opposite the dielectric layer thereon.

36. The method of claim 35 which further comprises the step of laminating the entire structure such that the polymeric layer and/or the additional polymeric layer surround the patches of the dielectric layer.

37. The method of claim 30 wherein the dielectric layer comprises a sheet comprising the first dielectric material and having a plurality of perforations therethrough, and wherein at least some of the perforations contain patches of the different dielectric material positioned within the perforations.

38. The method of claim 37 which further comprises the step of laminating the entire structure such that the polymeric layer and/or the additional polymeric layer fill at least some of the perforations through the sheet of first dielectric material.
